(19) United States
(12) Patent Application Publication
(10) Pub. No.: US 2008/0104427 A1
(43) Pub. Date: May 1, 2008

(54) Multi-stage power supply

(75) Inventors: Dawson Yee, Bellevue, WA (US); Ceasar de Leon, Redmond, WA (US); Mingwei Hsu, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/588,642

(22) Filed: Oct. 27, 2006

(51) Int. Cl. G06F 1/00

(52) U.S. Cl. 713/300

(57) ABSTRACT

A multi-stage power supply for providing power to a network powered device such as a Power-over-Ethernet (PoE) power device (PD) is disclosed. The multi-stage power supply comprises: a primary power supply for supplying primary power input of the PD; and a supplemental power supply for supplying supplemental power input of the PD. The supplemental power supply supplies power without substantially changing the power supplied by the primary power supply.

### BACKGROUND

Devices such as personal computers, printers, facsimile machines, network telephones, etc., connected to a network, such as an Ethernet type network (collectively network devices) require power and a way to communicate with the network. Often the power is supplied by a power cable connected from the network device to an alternating current (AC) power outlet and the network connection is provided by a communication cable connected from the network device to a network connector, e.g., a wall mounted network socket. Hence, it is often necessary that the network device be located near both a network connector and an AC power outlet. Preferably, the network device is physically located within a short distance, e.g., four feet, of a network connector and within a similar distance of an AC outlet. Besides restricting network device locations, connecting a network device to both a network connector and an AC outlet requires the use of two cables—a network cable, e.g., an Ethernet cable, and an AC power cable.

Rather than employing separate power and communication cables, a technology, known as Power-over-Ethernet (PoE), has been developed that enables network devices to receive both power and communication over a single cable connected to an Ethernet type device. PoE avoids the need for a power cable and a communication cable, thereby reducing cost. Further, eliminating the need for an AC power connection provides more device location options. Depending on the capability of network devices, PoE technology can be used to provide enhanced operational support by enabling remote management of the electrical power supplied to the network devices. For example, if a problem such as a breach of security is detected on a PoE-enabled device, i.e., a device powered by PoE power, the device can be remotely disabled by shutting off power to the device. Other PoE-based features include the monitoring PoE devices' condition and consumption of power, which enhance the ability to ensure smooth and efficient network operations.

In order to keep the power requirements of PoE power source equipment, i.e., the equipment that supplies power to PoE-enabled devices, at an acceptable level, PoE standards limit the power allotted to each PoE-enabled device to a predetermined level, presently 14 watts (W), which in practice effectively limits the power available to each device to about 13 W. While many PoE-enabled devices are able to satisfactorily operate with the 13 W limitation, certain PoE-enabled devices can benefit if supplemental power is available. For example, some PoE-enabled Internet protocol telephones, i.e., IP phones, having a display can benefit. More specifically, many IP phones include a backlit display. The brightness of the backlight is controlled by the available power. In many instances, it would be desirable for a PoE-enabled IP phone to have more available power than that provided by PoE power source equipment in order to increase backlight brightness and, thus, improve display clarity.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and apparatus for providing supplemental power to a network powered device is disclosed. Current produced by a supplemental power source is summed with the current produced by the network power source equipment, resulting in a multi-stage power supply. The summed current is applied to the network powered device or at least the portion of the network powered device whose functionality can be improved by increased power, such as the backlight of a display. The supplemental power source can be a constant current source or a voltage source whose output voltage is equal to or less than the voltage supplied by the network power source equipment to the network powered device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary pictorial diagram of a PoE enabled device (PD) that receives power from PoE power source equipment and supplemental power from an exemplary supplementary power source;

FIG. 2 is an electronic pictorial and schematic diagram of an exemplary circuit for supplying supplemental power to a PD; and

FIG. 3 is an electronic pictorial and schematic diagram of another exemplary circuit for supplying supplemental power to a PD.

### DETAILED DESCRIPTION

As will be readily appreciated by those skilled in the art and others from the foregoing and following descriptions, the disclosed subject matter was developed for use in connection with an Ethernet type network to supply additional power to PoE enabled devices (PDs). While developed for use with Ethernet type networks and PDs, it will be appreciated that embodiments may also find use in other types of networks wherein network devices that are normally powered by the network may effectively or efficiently employ external power without substantially changing the power supplied by the network. In this regard, one advantage of the disclosed subject matter is that supplemental power is supplied to a network device, i.e., a device that is normally or at least partially powered by a network, without substantially reducing the power supplied by the network. As a result, the network power requirements do not substantially fluctuate as would be the case if a substitute, as opposed to a supplemental, power source is used to supply power to the network device.

As noted above, the disclosed subject matter was developed for use in connection with an Ethernet type network. In order to better understand the disclosed subject matter, various voltage, current, and power values are included in the description. These values should be considered as exemplary and not limiting since different values may be used in other embodiments, including those used with Ethernet type networks and those used with other types of networks.

PoE technology enables an appropriately designed network device, i.e., a PoE enabled device (PD), to receive power through a network cable, i.e., an Ethernet cable, thus avoiding the need to connect the PD to an AC or DC power source, such as an AC power outlet or a DC power supply. The current industry standard governing PoE technology, IEEE 802.3af, describes, among other items, two categories of components: Power Sourcing Equipment (PSE) and PoE enabled or powered devices, i.e., PDs. In an Ethernet type network (“Ethernet”), PSEs supply power to PDs. Upon connection of any network device to an Ethernet, a PSE first determines if the network device is or is not a PD. This determination ensures that Ethernet devices and equipment that are not PoE compliant are not supplied with PoE power and, thereby, possibly damaged.

The PSE detects the presence or absence of PDs by applying two small current limited voltage signals across the Ethernet cable and checks for the presence of a characteristic resistance. PoE power is provided only if the specified resistance is detected. Optionally, a PD may provide data indicating how much power the PD requires from the PSE, enabling the PSE to supply power efficiently. In the absence of such data, after the PSE has determined that a network device is a PD, the PSE makes a maximum current of 350 milliamps (mA) at 48 volts (V) available to the PD. Accounting for the voltage drop due to the cable losses, a minimum of about 13 W is available to the PD. The available power, approximately 13 W, is enough power for devices such as, but not limited to, Voice over Internet Protocol (VoIP) telephones, i.e., IP phones, wireless application protocol devices (WAPs), security cameras, and building access systems. After a PSE provides power to a PD, the PSE continuously monitors the current draw of the PD. If the PD current draw drops below a minimum value, which may occur if the PD is disconnected from the Ethernet, the PSE discontinues supplying power to the PD. If the PD is reconnected to the Ethernet, the PSE once again determines if the device is a PD before supplying power.

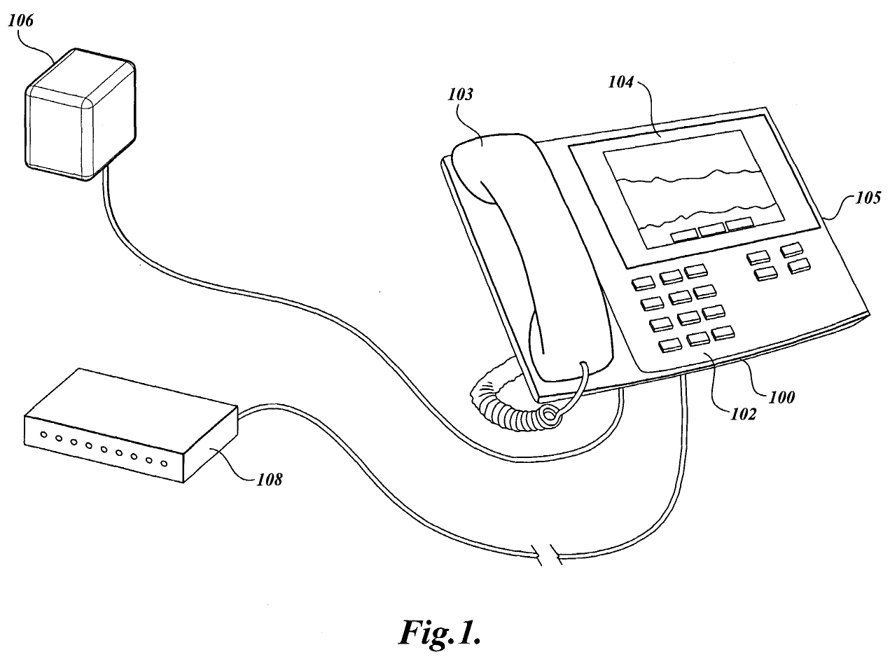

FIG. 1 is a pictorial diagram illustrating a PD powered by a PSE and a supplemental power supply. More specifically, FIG. 1 illustrates an exemplary IP phone 100, a conventional AC to DC convertor 106 and a network switch 108. The IP phone 100 includes a keypad 102, a handset 103 and a display 104 mounted in a housing 105 that also includes suitable IP phone circuitry (not shown in FIG. 1). In this example, the display 104 of the IP phone 100, is a backlit display, the backlighting included to improve the viewability of the display. The backlight may be, for example, an array of light-emitting diodes (LEDs) that, when lit, provide light that shines through the display and enhances the viewability of the display. The IP phone 100 is connected to the network switch 108 and the DC output of the AC to DC convertor 106. The EP phone 100, which is an exemplary PD, is supplied with power from a PSE, depicted as the network switch 108. The PoE power delivered by the network switch 108 in this Ethernet example is approximately 13 W, with the voltage varying between 40 and 48 volts of direct current (VDC). The PD, i.e., IP phone 100, receives supplemental power from the AC to DC convertor 106 in the manner hereinafter described. The power adapter is an electrical transformer that reduces the voltage of the supplemental power from a normal alternating current (AC) value, such as 110 volts (VAC), to a suitable VDC value, such as 12 VDC.

While the power from the PSE may render the telephone IP phone display 104 viewable under normal ambient lighting conditions, there may be ambient lighting conditions that require the display to be brighter in order to be easily viewable—bright ambient light, for example. Under such conditions, as described more fully below, the power supplied by the AC to DC convertor 106 supplies supplemental power to the IP telephone 100 that is used to increase the power applied to the backlight increasing the brightness of the display. The display supplemental power is thereby added to the PoE power provided by the PSE, avoiding, or at least minimally impacting the power provided to the PD by the PSE. The technique of providing supplemental power to a powered device without significantly impacting the normal power applied to the device is referred to herein as multi-stage power operation, i.e., powering a device from multiple power sources in a staged manner.

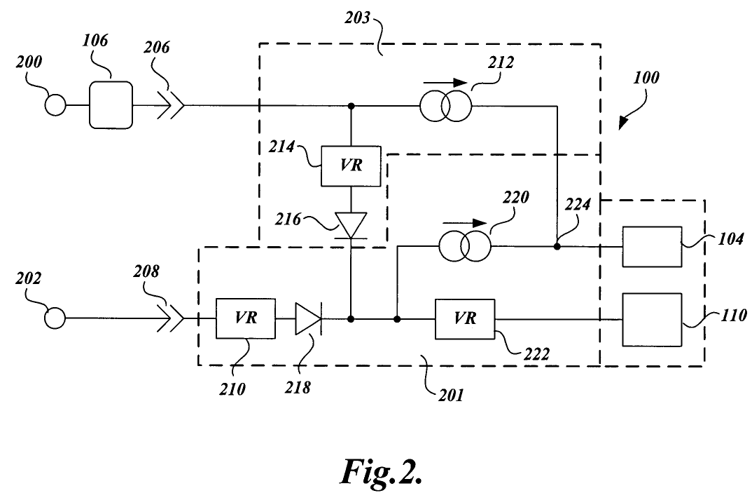

An exemplary multi-stage power supply suitable for inclusion in a PD of the type illustrated in FIG. 1, i.e., an IP phone with a backlit display, is shown in FIG. 2. For ease of illustration and discussion, the ground connections of the components included in the illustrated multi-stage power supply are not shown in FIG. 2. More specifically, FIG. 2 is a partially pictorial and partially schematic diagram that includes the IP phone 100 and the AC to DC convertor 106. As in FIG. 1, the IP phone 100 includes a display 104. The IP phone 100 also includes various conventional electronic components 110, represented by a block. The various conventional electronic components 110 include the keypad 102, the handset 103, and electronic circuitry of the type normally included in an IP phone, the details of which are not relevant to the disclosed subject matter and, thus, are not described.

Also illustrated in FIG. 2 are primary stage power supply 201 and supplemental stage power supply 203. As will be better understood from the following description, the primary stage power supply 201 and the supplemental stage power supply combine to form a multi-stage power supply for the illustrated IP phone 100. Preferably, both the primary stage power supply and the supplemental stage power supply are housed in the IP phone housing and, thus, in essence form part of the IP phone. The illustrated primary stage power supply includes first and second voltage regulators (VRs) 210 and 222, a first diode 218, and a first constant current source (CCS) 220.

Primary power is provided to the primary stage power supply 201 shown in FIG. 2 by a PSE such as the network switch 108 shown in FIG. 1. The PoE power provided by the PSE, i.e., the primary power, is represented in FIG. 2 by a power terminal 202. In accordance with current PoE standards, the level of the voltage at power terminal 202 and, thus, the connector 208 that connects the primary power to the primary stage power supply 201 is between +40 and +48 VDC.

The primary power is first regulated by the first VR 210. The thusly regulated power is applied to the second VR 222 via the first diode 218. The regulated output of the second VR is applied to the various electronic components 110, as required. The output of the first diode is also connected to the first CCS 220, which supplies a constant amount of current to the backlight of the display 104 at the regulated voltage output of the first VR 210.

As will be readily appreciated from the foregoing description, current flows from power terminal 202 through connector 208 to the first VR 210. The first VR 210 regulates the voltage down to some suitable level, such as +12 VDC. Current flows from the first VR 210 through the first diode to the second VR 222, resulting in a slight voltage drop. By way of example only, the voltage drop across a standard diode is usually on the order of 0.7 VDC. Thus, in this example, the voltage on the cathode side of the first diode is +11.3 VDC. This voltage is further regulated by the second VR 222 down to a suitable voltage, such as +5 VDC. The current flowing from the power terminal 202 through the first VR 210, the first diode 218, and the second diode 222 provides power to the various conventional components 110 of the IP phone 100.

As noted above, the cathode of the first diode is also connected to the input of the first CCS 220. Hence, some of the current flowing through the first diode 218 also flows to the first CCS 220. The first CCS 220 supplies constant current power to the display 104, or more precisely, to the backlight of the display 104. The current supplied to the backlight of the display by the first CCS 220 may be 60 mA, for example.

The supplemental stage power supply 203 includes a third voltage regulator (VR) 214, a second diode 216, and a second constant current source (CCS) 212. The supplemental power supply receives DC power for the AC to DC convertor 106, which is connected to a suitable AC supply 200, such as a conventional AC outlet. By way of example only, the AC to DC converter may produce 12 VDC power. The power produced by the AC to DC convertor is applied to the supplemental power supply components via a connector 206. More specifically, the connector 206 is connected to both the input of the third VR 214 and to the input of the second CCS 212. The output of the third VR is applied to the junction between the cathode of the first diode 218 and the second VR 222 via the second diode 216. The second diode is forward connected, i.e., the anode of the second diode is connected to the output of the third VR 214, and the cathode of the second diode is connected to the junction between the cathode of the first diode 218 and the input of the second VR 222. The output of the second CCS 212 is connected to a junction 224 at the output of the CCS 220 and, thus, to the display 104, or more precisely, the backlight of the display 104.

As will be appreciated from the foregoing description, current supplied to the supplemental stage power supply 203 flows from the connector 206 to the second CCS 212 and to the third VR 214. The third VR 214 regulates the voltage down to a suitable level, such as +9 VDC at the anode of the second diode 216. The voltage at the cathode of the second diode 218 is reduced by the voltage drop across the second diode 216. If the voltage drop is 0.7 VDC, the resulting voltage at the cathode of the second diode 216 in this example would be +8.3 VDC. Since the voltage at the cathode of the diode 218 in this example is +11.3 VDC, whereas the voltage at the cathode of the second diode would be +8.3 VDC, if the second diode were conducting, the second diode would be reversed biased. The second diode remains reverse biased as long as the voltage at the cathode of the first diode 218 remains above the second diode cathode voltage—+8.3 VDC in this example. As a result, normally no current flows through the second diode 216. If the voltage at the cathode of the first diode 218 drops below the second diode cathode voltage, i.e., +8.3 VDC, the second diode begins to conduct and provide current to the various conventional electronic components 110.

The supplemental power at the connector 206 is also provided to the second CCS 212. The second CCS 212 provides supplemental current to the junction 224 located at the output of the first CCS 220. The current supplied by the second CCS 212 is summed with current supplied by the first CCS 220 to provide a greater amount of power to the backlight of the display 104 of IP phone 100. For example, 100 mA of supplemental current may be supplied. Thus, in this example, rather than 60 mA being supplied to the PoE PD, e.g., the IP phone 100, 160 mA are supplied. The end result is a substantially brighter display due to the increased backlight power.

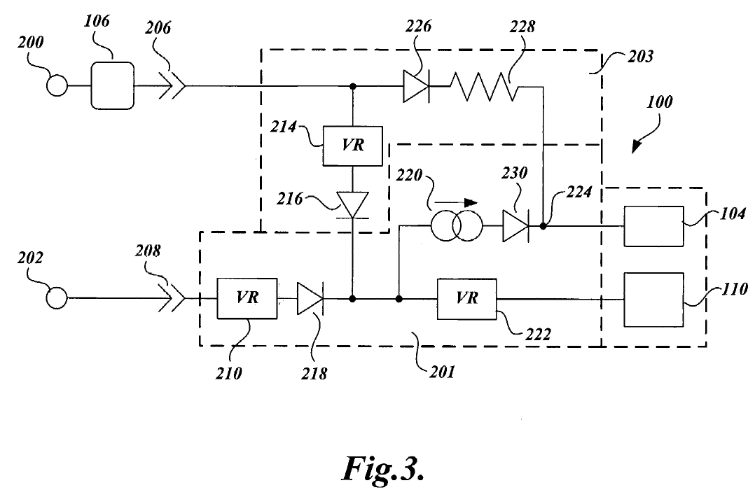

While it is preferable to use constant current sources such as the first and second CCSs 212 and 220 to provide constant current, it is possible to use other components to provide additional current. An exemplary multi-power stage supply circuit that uses other components to provide additional current is illustrated in FIG. 3. The multi-stage power supply illustrated in FIG. 3 is substantially identical to the multi-stage power supply illustrated in FIG. 2, except that the second CCS 212 (FIG. 2) is replaced by a third diode 226 connected in series with a resistor 228; and a fourth diode 230 is connected between the output of the first CCS 220 and the junction 224. More specifically, connector 206 is connected to the anode of the third diode 226 and the cathode of the third diode 226 is connected through the resistor 228 to the junction 224. The output of the first CCS 220 is connected to the anode of the fourth diode 230, and the cathode of the fourth diode 230 is connected to the junction 224.

In FIG. 3, the voltage output of the first CCS 220 is reduced by the voltage drop across the fourth diode 230. The fourth diode 230 prevents reverse current flow through the first CCS 220 in the event that the voltage supplied to the junction 224 by the series connected third diode 226 and resistor 228 exceeds the voltage at the cathode of the third diode 230 created by the first CCS 220. The first CCS 220 via the third diode 230 provides constant current power to the backlight of the display 104 of the IP telephone 100. As in the previous example, the constant current may be 60 mA.

Supplemental backlight power is provided by the series connected fourth diode 226 and resistor 228. The voltage of the current provided by the series connected fourth diode 226 and resistor 228 to junction 224 is preferably greater than, or at least equal to the voltage at the cathode of the third diode 230. As a result, the current provided by the series connected fourth diode 226 and resistor 228 is summed with the current provided by the first CCS 220 and third diode 230. As a result, the level of the current supplied to the backlight of the display 104 of IP phone 100 is increased, creating a brighter display.

The multi-stage power supply illustrated in FIGS. 2 and 3 and discussed above provide supplemental power to network devices without interrupting or disturbing the PoE supplied power. As a result, the electrical power supplied to PoE network devices does not significantly fluctuate as would be the case if the PoE supplied power were removed and replaced with an auxiliary power supply. As a result, PoE supplied power is better managed.

The voltage regulators used in the multi-stage power supply circuits illustrated in FIGS. 2 and 3 and discussed above may be fixed voltage regulators or adjustable voltage regulators. While it is possible to assemble a voltage regulator from discrete parts, preferably, the voltage regulators are integrated circuits whose dedicated function is to keep voltage at a specific level. While it is possible to assemble a constant current source from discrete parts, preferably, the constant current sources are integrated circuits whose dedicated function is to maintain a constant current despite fluctuating input voltage.

While the above examples describe providing supplemental power to the backlight of an IP phone display, it is to be understood that a multi-stage power supply may also find use in other applications where higher performance without disturbing a primary power flow is desired, such as, but not limited to, other types of networks, electric vehicles, wind turbines, and photovoltaic power panels, for example.

While illustrative embodiments have been illustrated and described, it will be appreciated that various changes can be made therein without departing from the spirit and scope of the invention. For example, while the stages of the multi-stage power supply shown in FIGS. 2 and 3 are described as being included in the IP phone 100 shown in FIG. 1, they may be included in other electronic devices. Further, the multi-stage power supply components may be implemented as discrete components, as sets of discrete components, or integrated components. Hence, the herein described multi-stage power supply should be construed as exemplary and not limiting.

The embodiments of the invention in which an exclusive property or privilege is claimed are defined as follows:

1. A multi-stage power supply for providing supplemental power to a device without substantially changing the primary power supplied to the device comprising:
primary stage power supply for supplying power from a primary power source to the device; and
a supplemental stage power supply for supplying power from a supplemental power source to the device without substantially changing the power supplied to the device by the primary stage power supply.

2. A multi-stage power supply as clamed in claim 1, wherein the device is a Power-over-Ethernet (PoE) power device (PD).

3. A multi-stage power supply as claimed in claim 2, wherein the PD is an IP phone including a backlit display and the primary and supplemental stage power supplies supply power to the backlight of the display to increase the brightness of the display.

4. A multi-stage power supply as claimed in claim 3, wherein both the primary and supplemental stage power supplies supply constant current to the backlight of the display.

5. A multi-stage power supply as claimed in claim 4, wherein the primary stage power supply also supplies power to the conventional components of the IP phone.

6. A multi-stage power supply as claimed in claim 5, wherein the primary stage power supply comprises:
a first voltage regulator (VR) for receiving power from PoE power sourcing equipment (PSE);
a first diode, the input of the first diode coupled to the output of the first VR;
a second voltage regulator (VR) coupled to the output of the first diode, the output of the second VR coupled to the inputs of the conventional components of the IP phone; and
a first constant current source (CCS) coupled to the output of the first diode, the first CCS coupled to the backlight of the display of the IP phone.

7. A multi-stage power supply as claimed in claim 6, wherein the supplemental power source is a DC power source and wherein the supplemental stage power supply comprises:
a third voltage regulator (VR) coupled to receive power from the DC power source;
a second diode coupled between the output of the third VR and the output of the first diode; and
a second constant current source (CCS) coupled to the DC source and to the output of the first CCS.

8. A multi-stage power supply for providing power to a network powered device comprising:
a primary stage power supply for coupling a network powered device to a network for supplying primary power to the network powered device; and
a supplemental stage power supply for supplying power from a supplemental power source to the network powered device without substantially changing the power supplied to the network powered device by the primary stage power supply.

9. A multi-stage power supply as clamed in claim 8, wherein the network powered device is a Power-over-Ethernet (PoE) power device (PD).

10. A multi-stage power supply as claimed in claim 9, wherein the PD is an IP phone including a backlit display and the primary and supplemental stage power supplies supply power to the backlight of the display to increase the brightness of the display.

11. A multi-stage power supply as claimed in claim 10, wherein the primary stage power supply supplies constant current to the backlight of the display.

12. A multi-stage power supply as claimed in claim 11, wherein the primary stage power supply also supplies power to the conventional components of the IP phone.

13. A multi-stage power supply as claimed in claim 12, wherein the primary stage power supply comprises:
a first voltage regulator (VR) for receiving power from PoE power sourcing equipment (PSE);
a first diode, the input of the first diode coupled to the output of the first VR;
a second voltage regulator (VR) coupled to the output of the first diode, the output of the second VR coupled to the inputs of the conventional components of the IP phone; and
a first constant current source (CCS) coupled to the output of the first diode, the first CCS coupled to the backlight of the display of the IP phone.

14. A multi-stage power supply as claimed in claim 13, wherein the supplemental stage power supply also supplies constant current to the backlight of the display.

15. A multi-stage power supply as claimed in claim 14, wherein the supplemental power source is a DC power source and wherein the supplemental stage power supply comprises:
a third voltage regulator (VR) coupled to receive power from the DC power source;
a second diode coupled between the output of the third VR and the output of the first diode; and
a second constant current source (CCS) coupled to the DC source and to the output of the first CCS.

16. A multi-stage power supply as claimed in claim 13, wherein the supplemental power supply is a DC power source and wherein the supplemental stage power supply comprises:
a third voltage regulator (VR) coupled to receive power from the DC power source;
a second diode coupled between the output of the third VR and the output of the first diode;
a third diode coupled to receive power from the DC power source; and
a resistor coupled between the output of the third diode and the output of the first CCs.

17. A method of supplying supplemental power to a network powered device receiving primary power from the network comprising:
converting power from a supplemental power source into a constant current source; and
applying current created by the constant current source to the network powered device so as to supplement the primary power in a way that does not substantially change the primary power supplied by the network to the network powered device.

18. The method of claim 17, wherein the network powered device is an IP phone.

19. The method of claim 16, wherein the network is an Ethernet type network.

20. The method of claim 19, wherein the network powered device is an IP phone.
